(19) United States
(12) Patent Application Publication
(10) Pub. No.: US 2025/0184276 A1
(43) Pub. Date: Jun. 5, 2025

(54) Traffic Patterned-Based Modem Function Adjustment Method and System Capable of Optimizing Network Strategy

(71) Applicant: MEDIATEK INC., Hsinchu City (TW)

(72) Inventors: Wei-Ming Yin, Hsinchu City (TW); Pei-Tsung Wu, Hsinchu City (TW); Yi-Ting Cheng, Hsinchu City (TW); Wan-Ting Huang, Hsinchu City (TW); Tsung-Ting Chiang, Hsinchu City (TW); Tsung-Ming Lee, Hsinchu City (TW); Chih-Chuan Cheng, Hsinchu City (TW); Kun-Lin Wu, Hsinchu City (TW); Chien-Li Chou, Hsinchu City (TW); Shang-An Tsai, Hsinchu City (TW); Hung-Lin Chang, Hsinchu City (TW); Chung-Pi Lee, Hsinchu City (TW)

(73) Assignee: MEDIATEK INC., Hsinchu City (TW)

(21) Appl. No.: 18/964,671

(22) Filed: Dec. 1, 2024

Related U.S. Application Data
(60) Provisional application No. 63/605,617, filed on Dec. 4, 2023.

(51) Int. Cl. H04L 47/24; H04B 7/06; H04L 41/50; H04W 76/28

(52) U.S. Cl. CPC H04L 47/24; H04B 7/0632; H04L 41/5087; H04W 76/28

(57) ABSTRACT

A traffic patterned-based modem function adjustment method includes receiving at least one traffic pattern by a user device, identifying the at least one traffic pattern by the user device for detecting a traffic mode of the user device, acquiring assisted information of the at least one traffic pattern by the user device, and adjusting at least one modem function according to the traffic mode and the assisted information. The at least one traffic pattern includes packet transmission characteristics, a radio signal status, and/or codec information of a network communicating with the user device.

### CROSS REFERENCE TO RELATED APPLICATIONS

This application claims the benefit of U.S. Provisional Application No. 63/605,617, filed on Dec. 4, 2023. The content of the application is incorporated herein by reference.

### BACKGROUND

Efficient utilization of resources like power and bandwidth is crucial in mobile communication. Modems, essential for signal modulation and demodulation, play a pivotal role in mobile devices. However, they conventionally operate with fixed settings regardless of the data type, leading to suboptimal performance, especially with variable traffic patterns. For example, high-definition video streaming demands higher modem configurations for smooth playback, while inactivity requires lower configurations to conserve power.

Fixed modem settings often present limitations. For instance, high-definition video streaming necessitates a higher modem configuration for smooth playback, demanding increased power and resources. Conversely, during periods of inactivity or low data usage, such as standby mode, a lower configuration suffices, conserving energy. Maintaining a high-power configuration during these times leads to unnecessary energy consumption.

This highlights the need for a mechanism enabling modems to dynamically adjust based on real-time traffic patterns.

### SUMMARY

In an embodiment of the present invention, a traffic patterned-based modem function adjustment method is disclosed. The traffic patterned-based modem function adjustment method comprises receiving at least one traffic pattern by a user device, identifying the at least one traffic pattern by the user device for detecting a traffic mode of the user device, acquiring assisted information of the at least one traffic pattern by the user device, and adjusting at least one modem function according to the traffic mode and the assisted information. The at least one traffic pattern comprises packet transmission characteristics, a radio signal status, and/or codec information of a network communicating with the user device.

In another embodiment of the present invention, a traffic patterned-based modem function adjustment system is disclosed. The traffic patterned-based modem function adjustment system comprises a feature extraction unit, a traffic pattern prediction unit linked to the feature extraction unit, a modem action unit linked to the traffic pattern prediction unit, and a closed-loop feedback unit linked to the modem action unit and the traffic pattern prediction unit. After at least one traffic pattern is received by the feature extraction unit, the feature extraction unit converts the at least one traffic pattern into feature metrics. The traffic pattern prediction unit identifies the at least one traffic pattern according to the feature metrics for detecting a traffic mode. The traffic pattern prediction unit generates at least one predicted pattern and assisted information of the at least one traffic pattern. The modem action unit adjusts at least one modem function according to the traffic mode and the assisted information. The closed-loop feedback unit monitors operations of the at least one modem function, and feedbacks a response to the traffic pattern prediction unit. The feature extraction unit, the traffic pattern prediction unit, a part of the modem action unit, and the closed-loop feedback unit form a user device. The at least one traffic pattern comprises packet transmission characteristics, a radio signal status, and/or codec information of a network communicating with the user device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a traffic patterned-based modem function adjustment system according to an embodiment of the present invention.

FIG. 2 is a block diagram of integrating a network of a serving cell and a modem function adjustment unit of a user device as a modem action unit of the traffic patterned-based modem function adjustment system in FIG. 1.

FIG. 3 is a block diagram of individually performing the modem action unit by the user device of the traffic patterned-based modem function adjustment system in FIG. 1.

FIG. 4 is an illustration of discrete packet traffic patterns under a buffered streaming mode of the traffic patterned-based modem function adjustment system in FIG. 1.

FIG. 5 is an illustration of continuous packet traffic patterns under a voice-over internet protocol mode of the traffic patterned-based modem function adjustment system in FIG. 1.

FIG. 6 is an illustration of receiving first traffic patterns for a first subscriber identity module (SIM) and second traffic patterns for a second SIM of the traffic patterned-based modem function adjustment system in FIG. 1.

FIG. 7 is a flow chart of performing a traffic patterned-based modem function adjustment method by the traffic patterned-based modem function adjustment system in FIG. 1.

### DETAILED DESCRIPTION

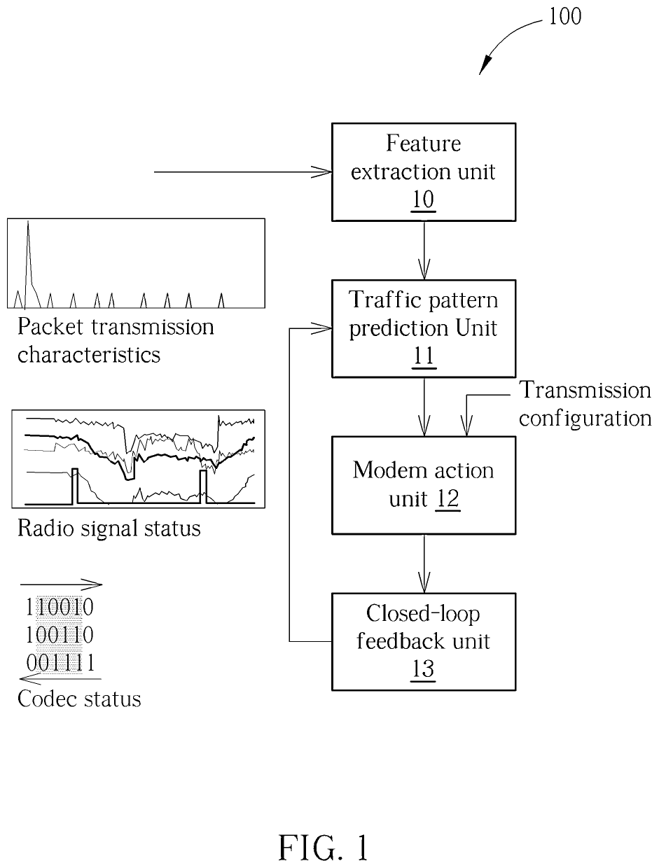

FIG. 1 is a block diagram of a traffic patterned-based modem function adjustment system 100 according to an embodiment of the present invention. The patterned-based modem function adjustment system 100 can identify the nature of the data transmission (i.e., video streaming, voice call, gaming) regardless of the specific application program (app) being used. Further, the patterned-based modem function adjustment system 100 can recognize that certain activities share the same underlying traffic pattern, even when performed in different apps. For example, a video call on WhatsApp® has a similar traffic pattern to a video call on Zoom®. In other words, the patterned-based modem function adjustment system 100 can adjust modem functions according to traffic patterns, which are independent of the app currently used. In FIG. 1, the patterned-based modem function adjustment system 100 includes a feature extraction unit 10, a traffic pattern prediction unit 11 linked to the feature extraction unit 10, a modem action unit 12 linked to the traffic pattern prediction unit 11, and a closed-loop feedback unit 13 linked to the modem action unit 12 and the traffic pattern prediction unit 11. The feature extraction unit 10 is used for gathering various types of information of at least one traffic pattern, and converts the at least one traffic pattern into feature metrics. Here, the at least one traffic pattern can include packet transmission characteristics, a radio signal status, and/or codec information of a network communicating with the user device. For example, the packet transmission characteristics can be the number of packets transmitted, packet size, and time intervals between packet arrivals. The radio signal status can be signal strength, waveform, and quality. The codec status can be audio or video codec information.

The traffic pattern prediction unit 11 analyzes feature metrics transmitted from the feature extraction unit 10. Then, the traffic pattern prediction unit 11 identifies the at least one traffic pattern according to the feature metrics for detecting a traffic mode, essentially determining the nature of the network activity being engaged in. Importantly, the traffic pattern prediction unit 11 can also predict future traffic patterns based on current and historical data (i.e., the feature metrics). These predictions, along with assisted information of the at least one traffic pattern generated by the traffic pattern prediction unit 11, such as data transmission rates or packet arrival times, are passed on to the modem action unit 12. This allows the modem action unit 12 to make informed decisions about adjusting modem functions for optimal performance and power efficiency.

The modem action unit 12 adjusts at least one modem function according to the traffic mode and the assisted information. The modem action unit 12 is a core component of the patterned-based modem function adjustment system 100, responsible for taking action based on outputs of the traffic pattern prediction unit 11. Further, the modem action unit 12 can also introduce the transmission configuration. In this embodiment, the transmission configuration refers to the specific settings and parameters that govern how the data is transmitted over a wireless network.

For example, the transmission configuration can include network-related parameters, such as the number of MIMO layers (which affects data transmission speed and reliability), the carrier aggregation settings (i.e., combining frequency bands for increased bandwidth), and/or the bandwidth part (BWP) configuration (i.e., defining the portion of the available bandwidth used by the device). The transmission configuration can also include device-related settings, such as the transmission power level used by the device, the modulation scheme (i.e., how data is encoded onto the radio wave), and/or the coding rate (i.e., the ratio of useful data bits to total bits transmitted, impacting error correction capabilities). Additionally, the transmission configuration can include protocol-specific settings, such as configurations for 5G NR (New Radio) or LTE (Long Term Evolution). Any reasonable technology modification falls within the scope of the present invention. Finally, the modem action unit 12 makes decisions about adjusting modem functions.

The closed-loop feedback unit 13 monitors the operations of the at least one modem function and feedbacks a response to the traffic pattern prediction unit 11. The closed-loop feedback unit 13 aims to dynamically monitor modem functions based on real-time data analysis. Its primary role is to monitor and evaluate the effectiveness of adjustments made by the modem action unit 12. For example, the closed-loop feedback unit 13 can arbitrate between power consumption and user experience, and determine if it is worthwhile to trigger modem function adjustments or reconfigurations. By introducing the closed-loop feedback unit 13, the traffic pattern prediction unit 11 can continuously learn and refine its prediction accuracy and adjustment strategies over time.

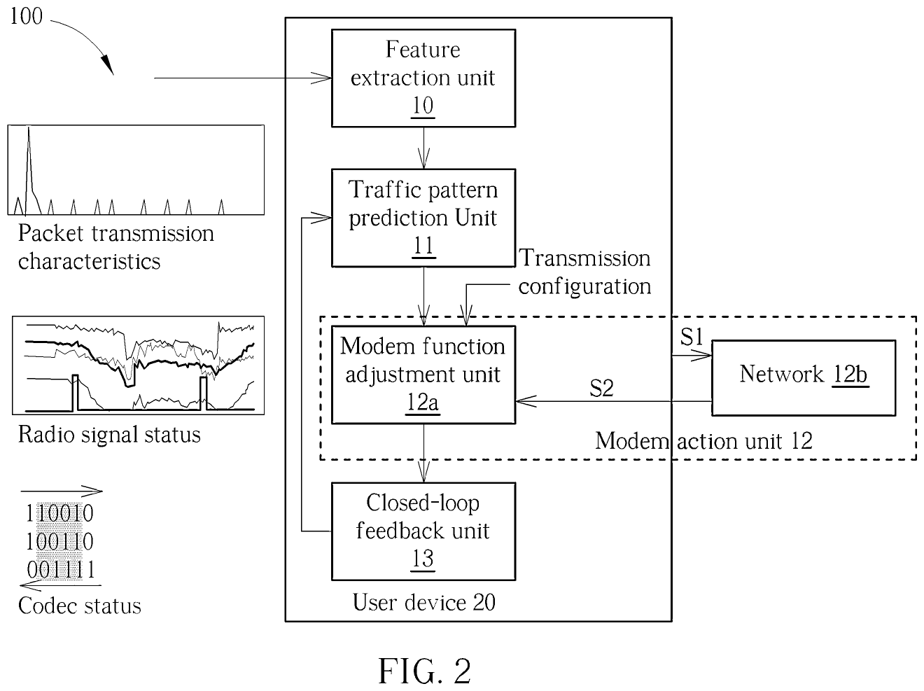

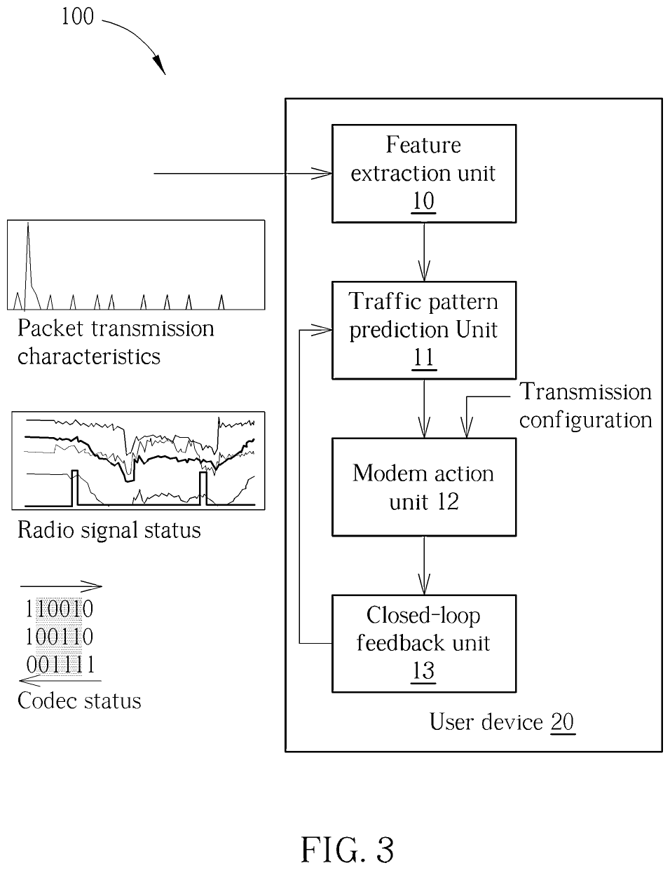

FIG. 2 is a block diagram illustrating the integration of a network 12b of a serving cell and a modem function adjustment unit 12a of a user device 20 as the modem action unit 12 of the traffic patterned-based modem function adjustment system 100. FIG. 3 is a block diagram illustrating the user device 20 of the traffic patterned-based modem function adjustment system 100 individually performing the functions of the modem action unit 12. In FIG. 2, the traffic patterned-based modem function adjustment system 100 can integrate the network 12b of the serving cell and the modem function adjustment unit 12a of the user device 20, together forming the modem action unit 12. In this embodiment, after the user device 20 transmits a signal S1 to the network 12b, the modem function adjustment unit 12a can be used for adjusting at least one modem function according to a control signal or an authorization signal S2 transmitted from the network 12b. In other words, the user device 20 comprises the feature extraction unit 10, the traffic pattern prediction unit 11, a part of the modem action unit 12 (i.e., the modem function adjustment unit 12a), and the closed-loop feedback unit 13. This architecture facilitates dynamic interaction between the network 12b and the user device 20, enabling real-time adaptation of modem functions based on at least one traffic pattern. In FIG. 3, the user device 20 includes the feature extraction unit 10, the traffic pattern prediction unit 11, the modem action unit 12, and the closed-loop feedback unit 13. The user device 20 can individually perform the functions of the modem action unit 12 for adjusting at least one modem function.

In FIG. 1 to FIG. 3, the traffic pattern prediction unit 11 can include a machine learning model. The traffic pattern prediction unit 11 employs the machine learning model to identify traffic patterns based on the feature metrics received from the feature extraction unit 10. This process involves utilizing the machine learning model that has been trained either online or offline using packet transmission information, radio signal information, and codec information. The choice of online or offline training depends on the specific implementation and requirements. Once the machine learning model is trained, it is deployed on the user device 20. Further, in the patterned-based modem function adjustment system 100, a processor disposed on a control circuit (such as a mainboard of the user device 20) can be used for driving the feature extraction unit 10, the traffic pattern prediction unit 11, the modem action unit 12, and the closed-loop feedback unit 13 by executing a program code stored in a memory. The memory disposed on the mainboard can be introduced for saving data. Further, since the user device 20 can be a mobile device, a single subscriber identity module (SIM) or dual SIMs linked to the processor can be introduced for use under a single traffic mode or different traffic modes, respectively.

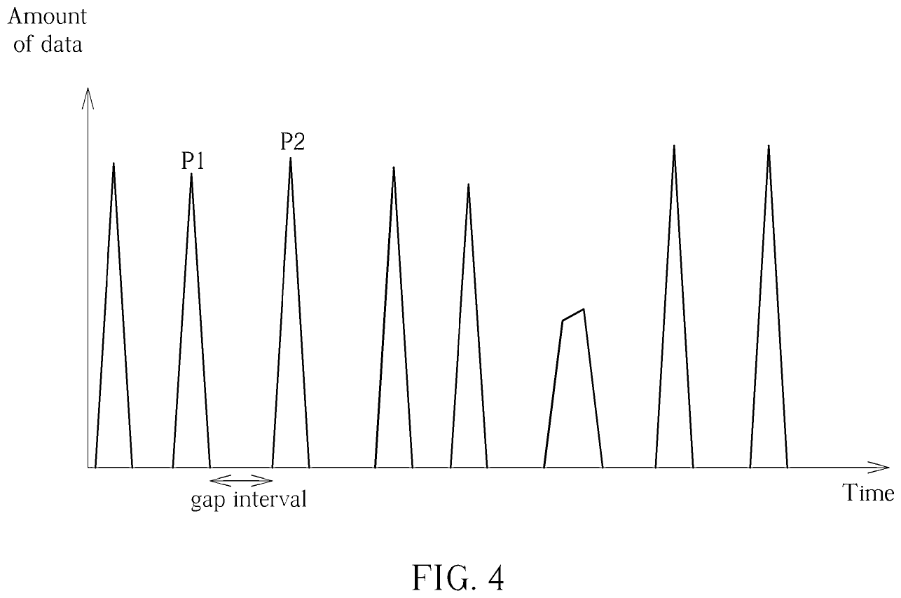

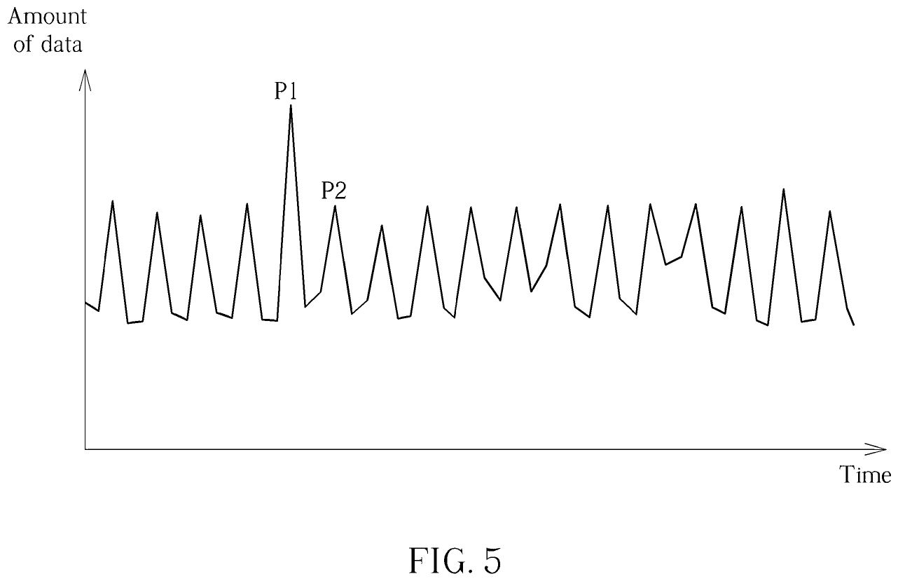

FIG. 4 is an illustration of discrete packet traffic patterns under a buffered streaming mode of the traffic patterned-based modem function adjustment system 100. FIG. 5 is an illustration of continuous packet traffic patterns under a voice-over internet protocol (VoIP) mode of the traffic patterned-based modem function adjustment system 100. In this embodiment, the packet traffic patterns can be discrete or continuous. For example, in FIG. 4, in the buffered streaming mode, the packet traffic patterns are discrete, which means there are some idle intervals with no data transmission. The x-axis represents timeline. The y-axis represents the amount of data. Here, a gap interval T between a packet traffic P1 and a packet traffic P2 can be regarded as the idle interval. The burst traffic patterns happen at the beginnings of traffic periods because the user device 20 downloads a certain amount of data for buffering, ensuring continuous streaming playback. Additionally, packet traffic patterns of a standby mode, an audio streaming mode, a web browsing mode, and a chat mode are discrete. For example, in FIG. 5, in the VoIP mode, the packet traffic patterns are continuous, which means there are no idle intervals. The x-axis represents timeline. The y-axis represents the amount of data. Here, the data rate is not high, which is generally only a few hundred Kbps. Moreover, the packets are time-sensitive. Any delayed packet needs to be dropped to ensure real-time voice quality. Additionally, packet traffic patterns of a live streaming mode and a gaming mode are continuous. Details of adjusting at least one modem function under various traffic modes are illustrated later.

In an audio stream mode or a standby mode, the assisted information includes the time duration of each period, such as a gap interval. In this embodiment, the user device 20 can extend a Connected Discontinuous Reception (CDRX) period or reduce a CDRX on-duration time interval when the arrival time range of a next predicted packet is longer than a time threshold. For example, the user device 20 is configured with a CDRX period of 160 milliseconds. The assisted information shows that the next packet will arrive in more than 3 seconds. Then, the user device 20 can send an assisted information signal to network 12b, which preferably provides CDRX parameters. Network 12b can then configure the user device 20 with a longer CDRX period to save power. In another embodiment, the user device 20 can perform a background search process to find another network cell during a gap interval between two adjacent packets when the service quality of the network is lower than a quality threshold. For example, if the quality of the serving cell is not good enough, or the resources are not properly allocated, the user device 20 can use the gap interval to perform measurements or a background search to find a better-quality cell for cell mobility (i.e., reselection, selection, handover). In particular, the user device 20 can take advantage of periods of inactivity to search for a better cell without interrupting ongoing data transmission.

In a live streaming mode or a VoIP mode, the assisted information includes the data transmission bit rate. It is expected that data transmission is continuous. The data rate is not high, and quality of user experience is a top priority. In this embodiment, the user device 20 can transmit a Rank Indication (RI) signal to the network for assigning low-layer data transmission by the network, or transmit a lower Channel Quality Indicator (CQI) in a Channel State Information (CSI) report for assigning a lower Modulation and Coding Scheme (MCS). For example, the user device 20 can signal the RI in the Physical Uplink Control Channel (PUCCH) or Physical Uplink Shared Channel (PUSCH). This means that the user device 20 informs network 12b that data with a lower rate is transmitted. Upon receiving this signal, network 12b can adjust the data transmission to occur in lower layers, such as 2 layers instead of 4 layers, to conserve power and resources. In another embodiment, the user device 20 can transmit the assisted information signal to network 12b for assigning preferred signal transmission parameters, or for boosting the decoding capability of the user device 20 to remove signal interferences. For example, the user device 20 can send the assisted information signal, which preferably provides the maximum number of MIMO layers, the maximum number of channel carriers, and bandwidth configurations. Then, the user device 20 can be reconfigured by network 12b with preferred signal transmission parameters to save power. Further, the user device 20 can leverage a skill to enhance Downlink Control Information (DCI) and/or Physical Downlink Shared Channel (PDSCH) decoding performance to ensure the quality of voice/video calls. This skill may involve employing an interference cancellation mechanism, which is a technique used for improving the quality of received signals by suppressing unwanted interference.

In a buffered streaming mode, an audio streaming mode, a web browsing mode, or a chat mode, the assisted information includes a data transmission bit rate. The data transmission is expected to be sparse, and the data rate is not high. In this embodiment, the user device 20 can transmit the RI signal to the network 12b for assigning low-layer data transmission, or transmit a lower CQI in the CSI report for assigning a lower MCS, or transmit the assisted information signal to the network 12b for assigning preferred signal transmission parameters. In another embodiment, the user device 20 can adjust transmitter power or receiver power by reducing decoding capability or baseband clock frequency. For example, the user device 20 can leverage a skill to adjust transmitter power and balance corresponding transmitter performance to save power. This skill can be applied to DPD (Digital Pre-Distortion) or ET (Envelope Tracking). DPD is a technique used for correcting signal distortions caused by the non-linearity of power amplifiers. ET is a technique used for dynamically adjusting the power supply voltage of a power amplifier based on the signal envelope. The user device 20 can also leverage a skill to reduce receiver power. This skill can relax RF (radio frequency) performance, reduce decoding capability, and lower the baseband clock frequency. Relaxing RF performance includes reducing the performance requirements of the RF front-end, such as receiver sensitivity and noise figure. Reducing decoding capability includes reducing the complexity and power consumption of the decoder. Lowering baseband clock frequency includes reducing the clock frequency of the baseband processor, which can reduce power consumption.

In a gaming mode, the assisted information includes a data transmission bit rate. The data transmission is expected to be time-critical, and the data rate is not high. In this embodiment, the user device 20 can transmit the RI signal to the network 12b for assigning low-layer data transmission or transmit the assisted information signal to the network 12b for assigning preferred signal transmission parameters. In another embodiment, the user device 20 can boost receiving and decoding capabilities by increasing the Low-Noise Amplifier (LNA) gain, increasing the receiving antenna amount, and/or performing an interference cancellation mechanism. The increased LNA gain helps improving received signal quality, which in turn boosts receiving and decoding performance. The increased antenna amount leads to better reception and decoding diversity of signals. Employing an interference cancellation mechanism helps mitigate the impact of interference on signal quality, further enhancing receiving and decoding performance.

In a high throughput mode, the assisted information includes a data transmission bit rate. The data transmission is expected to be continuous, and more network resources are required. The user device 20 can transmit the RI signal to the network 12b for assigning high-layer data transmission or transmit the assisted information signal to the network 12b for assigning preferred signal transmission parameters to gain more network resources. For example, in order to enhance throughput, the user device 20 can transmit the RI signal in the PUCCH or the PUSCH. According to the RI signal, the network 12b can be used for configuring data transmission in higher layers, such as 4 layers instead of 2 layers. As a result, the throughput can be enhanced, enabling faster data transmission. In another embodiment, the user device 20 can boost receiving and decoding capabilities by increasing the LNA gain, increasing the receiving antenna amount, and/or performing the interference cancellation mechanism.

In a standby mode, the assisted information includes an arrival time range of the next predicted packet. Little background traffic is expected, and the data rate is low. In this embodiment, the user device 20 can extend the CDRX period or reduce the CDRX on-duration time interval when the arrival time range of the next predicted packet is longer than a first time threshold. Alternatively, it can transmit the assisted information signal to the network 12b for releasing the radio resource control (RRC) connection when the arrival time range of the next predicted packet is longer than a second time threshold, which is greater than the first time threshold. For example, if the user device 20 predicts that the next packet will arrive after a delay longer than a threshold, it can transmit the assisted information signal to the network 12b. The assisted information signal includes the preferred CDRX parameters for the user device 20. Then, the network 12b can use the assisted information signal to configure the user device 20 with a longer CDRX cycle. This adjustment helps the user device 20 save power by reducing the frequency it needs to wake up and check for incoming data. Further, if the user device 20 predicts that the next packet will arrive after a larger delay, exceeding a certain threshold, it can communicate this information to the network 12b. Thus, the user device 20 can transmit the assisted information signal to the network 12b. The assisted information signal includes the preferred RRC state for the user device 20. Upon receiving the assisted information signal, the network 12b can then release the RRC connection to save power. In another embodiment, the user device 20 can reduce the frequency of measuring signals when the arrival time range of the next predicted packet is longer than a third time threshold, or search another network of a suitable cell according to the CDRX period previously determined when the arrival time range of the next predicted packet is longer than a fourth time threshold, which is greater than the third time threshold. For example, if the user device 20 predicts that the next packet will arrive after a large delay longer than a threshold time (i.e., 1 minute), the user device 20 can reduce the measurement frequency. The measurement frequency is how often the user device 20 measures signals of at least one network of the corresponding cell. This modem function is performed when the packet arrival rate is relatively low, indicating that the need for frequent measurements is reduced. If the assisted information shows that the next packet will arrive later than a threshold time (i.e., 10 minutes), it implies that the user device 20 will enter a long idle state. Therefore, the user device 20 can search and reselect a power-saving suitable cell based on measured signal quality and cell CDRX cycle configuration.

In another embodiment of the VoIP mode, the assisted information includes the data transmission bit rate. The data transmission is expected to be continuous. The data rate is not high. However, packets are time-sensitive. They can be dropped but cannot be delayed. Here, the user device 20 can drop a User Datagram Protocol (UDP) packet when it is delayed over a waiting time threshold (such as 1 second) or adjust some protocol timers, which may result in some delayed PDUs being dropped. These protocol timers govern various aspects of data transmission and reception, such as timeouts and retransmission intervals. In another embodiment, the user device 20 can temporarily cease a cell network search process during a time interval of performing the VoIP mode. For example, in a cellular communication system, the user device 20 needs to periodically search for available networks. This process is called a PLMN (Public Land Mobile Network) search. During VoIP, if the user device 20 initiates the PLMN search, it may lead to a temporary interruption in the call or even a call drop. This is because the search process can cause the UE to release the existing RRC connection, which is responsible for maintaining the call. To avoid this, the user device 20 can delay the higher-priority PLMN search while a VoIP call is in progress. By postponing the search, the user device 20 ensures that the RRC connection remains active, preventing call drops and maintaining voice quality. Once the call ends, the user device 20 can resume the PLMN search to update its network information.

In another embodiment, the user device 20 can temporarily cease a network switching process through an N1-mode disable timer during a time interval of performing the VoIP mode or search another network of a suitable cell. For example, the user device 20 can avoid call drops by delaying an N1-mode disable timer to keep camping on LTE to ensure continuous voice call connectivity. The N1-mode disable timer is part of the 4G (LTE) and 5G network specifications. When the user device 20 is in LTE mode and conditions suggest it could switch to 5G (i.e., like improved 5G signal strength), the N1-mode disable timer starts. When the N1-mode disable timer expires, the user device 20 is allowed to switch to the 5G network. However, during an ongoing voice call (VoIP or other types), switching from 4G to 5G can introduce instability, potentially leading to a call drop. Therefore, delaying the N1-mode disable timer prevents this switch from happening prematurely. By remaining “camped on LTE”, the call is more likely to continue uninterrupted. Once the call ends, the N1-mode disable timer can resume its normal function, allowing the user device 20 to switch to 5G if conditions are favorable. Further, the user device 20 can actively switch its connection to a more suitable cell. This reselection process is based on an evaluation of various “channel quality indexes”, which are metrics that indicate the quality of the radio link between the user device 20 and different cells. By reselecting a cell with better channel quality indexes, the user device 20 can establish a more stable and robust connection, leading to improved voice quality during calls. This can result in reduced call drops and an overall better user experience.

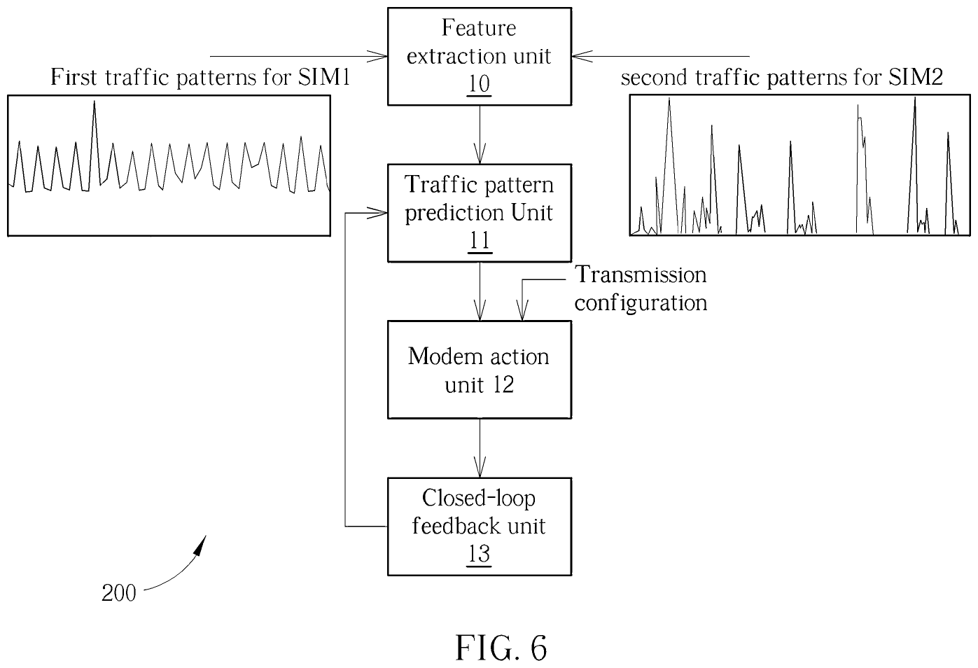

FIG. 6 illustrates receiving first traffic patterns for a first subscriber identity module (SIM) and second traffic patterns for a second SIM of the traffic pattern-based modem function adjustment system 100. As previously mentioned, dual SIMs can be introduced to the pattern-based modem function adjustment system 100 for different traffic modes. The feature extraction unit 10 can receive the first traffic pattern for the first SIM and the second traffic pattern for the second SIM. For example, the first SIM is detected to communicate the first traffic pattern under a high throughput mode, while the second SIM is detected to communicate the second traffic pattern under the standby mode. Under this scenario, the first SIM data transmission is expected to be uninterrupted if there is no emergency routine on the second SIM. The assisted information includes data transmission bit rates for two SIMs, a first arrival time range of the next predicted packet for the first SIM, and a second arrival time range of the next predicted packet for the second SIM.

Here, the user device 20 can delay a tracking area update (TAU) signal and/or a mobility registration update (MRU) signal triggered by the second SIM during a time interval of performing the high throughput mode of the first SIM. Alternatively, it can trigger the TAU signal and/or the MRU signal by the second SIM during a predicted idle period between two packets. For example, the TAU signal and the MRU signal are used for signaling procedures in 4G (TAU) and 5G (MRU) networks. They update the network about the user device 20's location and availability. In the dual-SIM scenario, certain network operations on one SIM might temporarily impact the performance or quality of the other SIM's connection. By postponing the TAU/MRU signaling on the second SIM, the user device 20 can prevent potential interruptions to data transmission or ongoing activities on the first SIM. When the traffic patterns of the first SIM are identified and categorized as a buffered streaming mode, it implies that the content is downloaded in chunks and stored in a buffer, allowing for continuous playback even if the network connection is intermittent. Since the traffic patterns are discrete, by triggering the TAU/MRU signaling on the second SIM during predicted periods without data transmission on the first SIM, the user device 20 can prevent potential interruptions of the streaming activity on the first SIM.

In another embodiment, the first SIM is detected to communicate the first traffic pattern under the VoIP mode, the gaming mode, or the live streaming mode, while the second SIM is detected to communicate the second traffic pattern under the standby mode. Under this scenario, the first SIM data transmission is expected to be under a better-quality serving cell to avoid transmission interruption. The assisted information includes the data transmission bit rates for two SIMs, the first arrival time range of the next predicted packet for the first SIM, and the second arrival time range of the next predicted packet for the second SIM. The user device 20 can reselect another network of a serving cell in a tracking area identity (TAI) list to avoid triggering the TAU signal and/or the MRU signal. For example, the TAI list includes a list of cells within a specific geographical area. When the user device 20 moves within this area, it doesn't need to update the network about its location. Therefore, when the user device 20 needs to perform data traffic, it can choose to connect to a serving cell already present in its TAI list. By doing so, the user device 20 can avoid performing a TAU/MRU signaling procedure, which can cause interruptions in data transmission lasting several hundred milliseconds.

Generally, when dual SIMs are introduced to the patterned-based modem function adjustment system 100, the first SIM is detected to communicate the first traffic pattern under the first mode, and the second SIM is detected to communicate the second traffic pattern under the second mode. The assisted information includes the data transmission bit rates for two SIMs, the first arrival time range of the next predicted packet for the first SIM, and the second arrival time range of the next predicted packet for the second SIM. For optimizing data traffic, some strategies can be introduced, as illustrated below. In the dual SIMs scenario, there is a chance that both SIMs need to simultaneously transmit or receive data, potentially leading to conflicts. Essentially, the user device 20 can intelligently assess the importance of the traffic modes being performed on each SIM. For instance, a voice call (VoIP mode) might be given precedence over a less critical task like web browsing or background app data syncing. By prioritizing the more important traffic mode of one SIM, the user device 20 ensures that the critical task experiences minimal disruption or performance degradation, even with simultaneous data transmission or reception on the other SIM. This selective prioritization contributes to a better user experience by maintaining the quality of the more critical task. In practice, a set of rules in any format can be defined to justify the priorities of traffic patterns between the first SIM and the second SIM. The user device 20 can process high-priority data by the uplink transmission scheduler. Alternatively, the user device 20 can reschedule an uplink data transmission period according to the gap interval between two consecutive packets and the priorities of the first mode and the second mode. In other words, in the dual SIMs scenario, performing network operations (i.e., measurement or background search) on one SIM might temporarily impact the performance or quality of the other SIM's connection. By using the “gap interval” of the packet traffic patterns on SIM2 (i.e., periods when it's inactive or has very low data traffic), the user device 20 can conduct these operations without affecting the traffic performance of the first SIM.

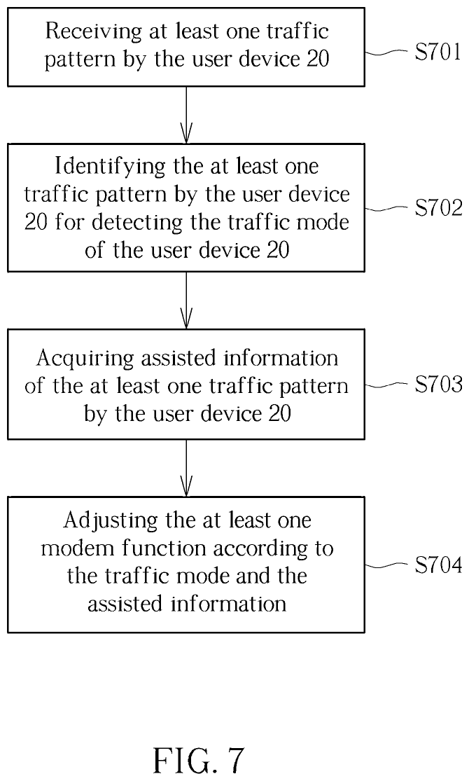

FIG. 7 is a flow chart of performing a traffic patterned-based modem function adjustment method by the traffic patterned-based modem function adjustment system 100. The traffic patterned-based modem function adjustment method includes step S701 to step S704. Any reasonable technology or hardware modification falls into the scope of the present invention. Step S701 to step S704 are illustrated below.
Step S701: receiving at least one traffic pattern by the user device 20;
Step S702: identifying the at least one traffic pattern by the user device 20 for detecting the traffic mode of the user device 20;
Step S703: acquiring assisted information of the at least one traffic pattern by the user device 20;
Step S704: adjusting the at least one modem function according to the traffic mode and the assisted information.

Details of step S701 to step S704 are previously illustrated and thus omitted here. In the patterned-based modem function adjustment system 100, since at least one traffic pattern can be identified and predicted, at least one modem function can be adjusted to enhance user experience. It should be understood that two or more actions can be triggered for a single prediction. For example, if the system predicts that the user is engaging in a video call, it can simultaneously trigger actions including adjusting the modem's configuration to prioritize video call traffic for optimal quality, temporarily suspending lower-priority tasks (i.e., background downloads) to free up resources, and switching to a more suitable cell tower with better signal quality.

To sum up, the embodiment discloses a patterned-based modem function adjustment method and a patterned-based modem function adjustment system. The method involves analyzing various factors like packet transmission characteristics, radio signal status, and codec information to identify the traffic pattern. The user device can then take actions such as adjusting the CDRX cycle, performing measurements or background searches during gap times, signaling the network to adjust transmission parameters, or managing dual SIM behavior to prioritize traffic. In other words, the embodiment provides a way to dynamically adjust modem functions according to traffic patterns, leading to improvements in power consumption, latency, and throughput.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A traffic patterned-based modem function adjustment method comprising:
receiving at least one traffic pattern by a user device;
identifying the at least one traffic pattern by the user device for detecting a traffic mode of the user device;
acquiring assisted information of the at least one traffic pattern by the user device; and
adjusting at least one modem function according to the traffic mode and the assisted information;
wherein the at least one traffic pattern comprises packet transmission characteristics, a radio signal status, and/or codec information of a network communicating with the user device.

2. The method of claim 1, wherein the traffic mode comprises an audio stream mode or a standby mode, the assisted information comprises a time duration of each period, and adjusting the at least one modem function according to the traffic mode and the assisted information comprises:
extending a connected discontinuous reception (CDRX) period or reducing a CDRX on-duration time interval by the user device when an arrival time range of a next predicted packet is longer than a time threshold; or
performing a background search process for finding another network of a cell during a gap interval between two adjacent packets when a service quality of the network is lower than a quality threshold.

3. The method of claim 1, wherein the traffic mode comprises a live streaming mode or a voice-over internet protocol (VoIP) mode, the assisted information comprises a data transmission bit rate, and adjusting the at least one modem function according to the traffic mode and the assisted information comprises:
transmitting a rank indication (RI) signal from the user device to the network for assigning a low-layer data transmission by the network; or
transmitting a lower channel quality indicator (CQI) in a channel state information (CSI) report for assigning a lower modulation and coding scheme (MCS).

4. The method of claim 1, wherein the traffic mode comprises a live streaming mode or a voice-over internet protocol (VoIP) mode, the assisted information comprises a data transmission bit rate, and adjusting the at least one modem function according to the traffic mode and the assisted information comprises:
transmitting an assisted information signal from the user device to the network for assigning preferred signal transmission parameters by the network; or
boosting a decoding capability of the user device for removing signal interferences.

5. The method of claim 1, wherein the traffic mode comprises a buffered streaming mode, an audio streaming mode, a web browsing mode, or a chat mode, the assisted information comprises a data transmission bit rate, and adjusting the at least one modem function according to the traffic mode and the assisted information comprises:
transmitting a rank indication (RI) signal from the user device to the network for assigning a low-layer data transmission by the network; or
transmitting a lower channel quality indicator (CQI) in a channel state information (CSI) report for assigning a lower modulation and coding scheme (MCS).

6. The method of claim 1, wherein the traffic mode comprises a buffered streaming mode, an audio streaming mode, a web browsing mode, or a chat mode, the assisted information comprises a data transmission bit rate, and adjusting the at least one modem function according to the traffic mode and the assisted information comprises:
transmitting an assisted information signal from the user device to the network for assigning preferred signal transmission parameters by the network; or
adjusting a transmitter power or a receiver power by reducing a decoding capability or a baseband clock frequency of the user device.

7. The method of claim 1, wherein the traffic mode comprises a gaming mode, the assisted information comprises a data transmission bit rate, and adjusting the at least one modem function according to the traffic mode and the assisted information comprises:
transmitting a rank indication (RI) signal from the user device to the network for assigning a low-layer data transmission by the network; or
transmitting an assisted information signal from the user device to the network for assigning preferred signal transmission parameters by the network.

8. The method of claim 1, wherein the traffic mode comprises a gaming mode, the assisted information comprises a data transmission bit rate, and adjusting the at least one modem function according to the traffic mode and the assisted information comprises:
boosting a receiving capability and a decoding capability of the user device by increasing a Low-Noise Amplifier (LNA) gain, increasing a receiving antenna amount, and/or performing an interference cancellation mechanism.

9. The method of claim 1, wherein the traffic mode comprises a high throughput mode, the assisted information comprises a data transmission bit rate, and adjusting the at least one modem function according to the traffic mode and the assisted information comprises:
transmitting a rank indication (RI) signal from the user device to the network for assigning a high-layer data transmission by the network; or
transmitting an assisted information signal from the user device to the network for assigning preferred signal transmission parameters by the network.

10. The method of claim 1, wherein the traffic mode comprises a high throughput mode, the assisted information comprises a data transmission bit rate, and adjusting the at least one modem function according to the traffic mode and the assisted information comprises:
boosting a receiving capability and a decoding capability of the user device by increasing a Low-Noise Amplifier (LNA) gain, increasing a receiving antenna amount, and/or performing an interference cancellation mechanism.

11. The method of claim 1, wherein the traffic mode comprises a standby mode, the assisted information comprises an arrival time range of a next predicted packet, and adjusting the at least one modem function according to the traffic mode and the assisted information comprises:
extending a connected discontinuous reception (CDRX) period or reducing a CDRX on-duration time interval by the user device when the arrival time range of the next predicted packet is longer than a first time threshold; or
transmitting an assisted information signal from the user device to the network for releasing an radio resource control (RRC) connection by the network when the arrival time range of the next predicted packet is longer than a second time threshold;
wherein the second time threshold is greater than the first time threshold.

12. The method of claim 1, wherein the traffic mode comprises a standby mode, the assisted information comprises an arrival time range of a next predicted packet, and adjusting the at least one modem function according to the traffic mode and the assisted information comprises:
reducing a frequency of measuring signals by the user device when the arrival time range of the next predicted packet is longer than a third time threshold; or
searching another network of a suitable cell by the user device according to a connected discontinuous reception (CDRX) period previously determined when the arrival time range of the next predicted packet is longer than a fourth time threshold;
wherein the fourth time threshold is greater than the third time threshold.

13. The method of claim 1, wherein the traffic mode comprises a voice-over internet protocol (VoIP) mode, the assisted information comprises a data transmission bit rate, and adjusting the at least one modem function according to the traffic mode and the assisted information comprises:
dropping a user datagram protocol (UDP) packet by the user device when the UDP packet is delayed over a waiting time threshold; or
temporarily ceasing a cell network search process during a time interval of performing the VoIP mode of the user device.

14. The method of claim 1, wherein the traffic mode comprises a voice-over internet protocol (VoIP) mode, the assisted information comprises a data transmission bit rate, and adjusting the at least one modem function according to the traffic mode and the assisted information comprises:
temporality ceasing a network switching process through an N1-mode disable timer during a time interval of performing the VoIP mode of the user device; or
searching another network of a suitable cell by the user device;
wherein a voice quality of the another network is better than a voice quality of the network currently camped on.

15. The method of claim 1, wherein receiving the at least one traffic pattern by the user device, is receiving a first traffic pattern of a first subscriber identity module (SIM) and a second traffic pattern of a second SIM.

16. The method of claim 15, wherein the first SIM is detected to communicate the first traffic pattern under a high throughput mode, the second SIM is detected to communicate the second traffic pattern under a standby mode, the assisted information comprises data transmission bit rates for the first SIM and the second SIM, a first arrival time range of a next first predicted packet for the first SIM, and a second arrival time range of a next second predicted packet for the second SIM.

17. The method of claim 16, wherein adjusting the at least one modem function according to the traffic mode and the assisted information comprises:
delaying a tracking area update (TAU) signal and/or a mobility registration update (MRU) signal triggered by the second SIM during a time interval of performing the high throughput mode of the first SIM; or
triggering the TAU signal and/or the MRU signal by the second SIM during a predicted idle period between two packets.

18. The method of claim 15, wherein the first SIM is detected to communicate the first traffic pattern under a voice-over internet protocol (VoIP) mode, a gaming mode, or a live streaming mode, the second SIM is detected to communicate the second traffic pattern under a standby mode, the assisted information comprises data transmission bit rates for the first SIM and the second SIM, a first arrival time range of a next first predicted packet for the first SIM, and a second arrival time range of a next second predicted packet for the second SIM.

19. The method of claim 18, wherein adjusting the at least one modem function according to the traffic mode and the assisted information comprises:
reselecting another network of a serving cell in a tracking area identity (TAI) list by the user device for avoiding triggering a tracking area update (TAU) signal and/or a mobility registration update (MRU) signal.

20. The method of claim 15, wherein the first SIM is detected to communicate the first traffic pattern under a first mode, the second SIM is detected to communicate the second traffic pattern under a second mode, the assisted information comprises data transmission bit rates for the first SIM and the second SIM, a first arrival time range of a next first predicted packet for the first SIM, and a second arrival time range of a next second predicted packet for the second SIM.

21. The method of claim 20, further comprising:
determining priorities of the first mode and the second mode according to the first traffic pattern and the second traffic pattern by a set of rules; and
rescheduling an uplink data transmission period according to a gap interval between two consecutive packets and priorities of the first mode and the second mode.

22. A traffic patterned-based modem function adjustment system comprising:
a feature extraction unit;
a traffic pattern prediction unit linked to the feature extraction unit;
a modem action unit linked to the traffic pattern prediction unit; and
a closed-loop feedback unit linked to the modem action unit and the traffic pattern prediction unit;
wherein after at least one traffic pattern is received by the feature extraction unit, the feature extraction unit converts the at least one traffic pattern into feature metrics, the traffic pattern prediction unit identifies the at least one traffic pattern according to the feature metrics for detecting a traffic mode, the traffic pattern prediction unit generates at least one predicted pattern and assisted information of the at least one traffic pattern, the modem action unit adjusts at least one modem function according to the traffic mode and the assisted information, and the closed-loop feedback unit monitors operations of the at least one modem function, feedbacks a response to the traffic pattern prediction unit; and
wherein the feature extraction unit, the traffic pattern prediction unit, a part of the modem action unit, and the closed-loop feedback unit form a user device, the at least one traffic pattern comprises packet transmission characteristics, a radio signal status, and/or codec information of a network communicating with the user device.
